(19) United States
(12) Patent Application Publication
(10) Pub. No.: US 2015/0258967 A1
(43) Pub. Date: Sep. 17, 2015

(54) UNIVERSAL CONNECTOR AND COVER FOR ATTACHMENT OF A WINDSHIELD WIPER BLADE WITH MULTIPLE TYPES OF WINDSHIELD WIPER ARMS

(71) Applicant: lIIinois Tool Works Inc., Glenview, IL (US)

(72) Inventors: Mark O. Lepper, Oak Park, IL (US); Kenneth H. Teal, Houston, TX (US); Liliana Minevski, The Woodlands, TX (US); James C. Fournier, Gurnee, IL (US)

(73) Assignee: llIinois Tool Works Inc., Glenview, IL (US)

(21) Appl. No.: 14/643,255

(22) Filed: Mar. 10, 2015

Related U.S. Application Data
(60) Provisional application No. 61/951,324, filed on Mar. 11, 2014.

(51) Int. Cl. B60S 1/40

(52) U.S. Cl. CPC B60S 1/4003

(57) ABSTRACT

A connector system for connecting a wiper blade and multiple types of wiper arms, the connector system including connector having a base for attachment to a wiper blade. The connector further includes a receiving element attached to the base, the receiving element having a structure to receive and be connected to at least six different wiper arms. The connector system includes a cover attached to the receiving element, the cover including a top wall, a first side attached to the top wall and extending toward the base and a second side parallel to the first side, attached to the top wall and extending toward the base, wherein the second side has a height larger than a height of the first side.

This application claims the benefit of priority under 35 U.S.C. §119(e)(1) of U.S. Provisional Application Ser. No. 61/951,324, filed Mar. 11, 2014, the entire contents of which is incorporated herein by reference.

### BACKGROUND

1. Technical Field

The present invention relates to a universal connector and cover for attachment of a windshield wiper blade with multiple types of windshield wiper arms.

2. Background Information

Automobiles use a variety of wiper arms to move a wiper blade. Since wiper blades need to be replaced periodically, a potential buyer of a wiper blade often has difficulty in identifying a wiper blade displayed in a store that can be attached with the wiper arm of his or her automobile. In the past, this situation has been addressed by supplying multiple connectors in either separate packages or with the wiper blade itself so that the consumer can match the appropriate connector with the wiper arm of the consumer's automobile. This practice can be cumbersome in that the consumer has to deal with multiple connectors. Furthermore, the connectors often come as multiple pieces which can be easy to lose. In addition, there may be situations where the connectors purchased are not appropriate for attachment to the consumer's wiper arm.

### BRIEF SUMMARY OF THE INVENTION

One aspect of the present invention regards a connector system for connecting a wiper blade and multiple types of wiper arms, the connector system including a connector having a base for attachment to a wiper blade. The connector further includes a receiving element attached to the base, the receiving element having a structure to receive and be connected to at least six different wiper arms. The connector system includes a cover attached to the receiving element, the cover including a top wall, a first side attached to the top wall and extending toward the base and a second side parallel to the first side, attached to the top wall and extending toward the base, wherein the second side has a height larger than a height of the first side.

A second aspect of the present invention regards a windshield wiper that includes a wiper blade, a wiper arm and a connector system. The connector system includes a base attached to the wiper blade and a receiving element attached to the base and the wiper arm. The receiving element has a structure to receive and be connected to the wiper arm. The connector system includes a cover attached to the receiving element, the cover including a top wall, a first side attached to the top wall and extending toward the base and a second side parallel to the first side, attached to the top wall and extending toward the base, wherein the second side has a height larger than a height of the first side.

A third aspect of the present invention regards a connector for connecting a wiper blade and multiple types of wiper arms, the connector including a receiving element attached to the wiper blade, the receiving element including a first side wall and a second side wall positioned opposite from and spaced from the second side wall, wherein exterior surfaces of the first side wall and the second side wall are spaced apart from one another at a first predetermined distance so that a first wiper arm can snugly engage the first side wall and the second side wall. The connector further includes a spacer that includes a first expansion wall having an interior surface that engages the exterior surface of the first side wall. The spacer also includes a second expansion wall having an interior surface that engages the exterior surface of the second side wall, wherein exterior surfaces of the first expansion wall and the second expansion wall are spaced apart from one another at a second predetermined distance so that a second wiper arm snugly engages the first expansion wall and the second expansion wall.

A fourth aspect of the present invention regards a windshield wiper including a wiper blade, a first wiper arm and a connector. The connector including a receiving element attached to the wiper blade, the receiving element including a first side wall and a second side wall positioned opposite from and spaced from the second side wall, wherein exterior surfaces of the first side wall and the second side wall are spaced apart from one another at a first predetermined distance so that a second wiper arm can snugly engage the first side wall and the second side wall. The connector further includes a spacer that includes a first expansion wall having an interior surface that engages the exterior surface of the first side wall. The spacer also includes a second expansion wall having an interior surface that engages the exterior surface of the second side wall, wherein exterior surfaces of the first expansion wall and the second expansion wall are spaced apart from one another at a second predetermined distance so that the first second wiper arm snugly engages the first expansion wall and the second expansion wall.

A fifth aspect of the present invention regards a method of attaching a wiper arm to a connector that is attached to a wiper blade. The method including providing a connector that is attached to a wiper blade, attaching an expander to the connector and attaching a wiper arm to the expander.

A sixth aspect of the present invention regards a method of removing a wiper arm from a connector that is attached to a wiper blade. The method includes providing a connector that is attached to a wiper blade, wherein an expander is attached to the connector. The method further includes removing the expander from the connector and attaching a wiper arm to the connector.

One or more aspects of the present invention provide the advantage of providing the possibility of attaching a wiper blade to multiple wiper arms by using just a single connector.

One or more aspects of the present invention provide the advantage of providing the possibility of attaching a wiper blade to multiple wiper arms with a connector of a single piece construction.

The accompanying drawings, which are incorporated herein and constitute part of this specification, and, together with the general description given above and the detailed description given below, serve to explain features of the present invention.

### BRIEF DESCRIPTION OF THE DRAWING

In the drawings:

FIG. 1A shows a perspective view of an embodiment of a connector for connecting a wiper blade and multiple types of wiper arms, wherein the cap is opened;

FIG. 1B shows a perspective view of the connector of FIG. 1A when the cap is closed;

FIG. 1C shows an exploded view of the connector of FIG. 1A;

FIG. 2 shows a left side view of the connector of FIG. 1B;

FIG. 3 shows a right side view of the connector of FIG. 1B;

FIG. 4 shows a top view of the connector of FIG. 1B;

FIG. 5 shows a bottom view of the connector of FIG. 1B;

FIG. 6 shows a front view of the connector of FIG. 1B;

FIG. 7 shows a rear view of the connector of FIG. 1B;

FIG. 8 shows a perspective view of an embodiment of a base to be used with the receiving element of FIGS. 1-7;

FIGS. 9A-D show three possible classes of connectors of wiper arms that can be attached to the connector of FIGS. 1A-C;

FIGS. 10A-B show a possible way of attaching a pin wiper arm to the connector of FIGS. 1A-C;

FIGS. 11A-D show possible ways of attaching a type of channel wiper arm, commonly known as a push tab button (PTB) wiper arm, to the connector of FIGS. 1A-C;

FIGS. 12A-C show a possible way of attaching a type of channel wiper arm, commonly known as an insert & lock (I & L) wiper arm, to the connector of FIGS. 1A-C;

FIGS. 13A-B show a possible way of attaching a J-hook wiper arm to the connector of FIGS. 1A-C;

FIG. 14A shows a side view of the connector of FIGS. 1A-C attached to a J-hook wiper arm;

FIG. 14B shows a top view of the connector and J-hook wiper arm of FIG. 14A;

FIG. 14C shows a cross-sectional view of the connector and J-hook wiper arm of FIG. 14A taken along line B-B of FIG. 14A;

FIG. 14D shows a cross-sectional view of the connector and J-hook wiper arm of FIG. 14A taken along line A-A of FIG. 14A.

FIG. 15 shows a top left side perspective view of an embodiment of a cover to be attached to the connector of FIGS. 1A-C;

FIG. 16 shows a right side view of the cover of FIG. 8;

FIG. 17 shows a left side view of the cover of FIG. 8;

FIG. 18 shows a front view of the cover of FIG. 8;

FIG. 19 shows a rear view of the cover of FIG. 8;

FIG. 20 shows a top view of the cover of FIG. 8;

FIG. 21 shows a bottom view of the cover of FIG. 8;

FIG. 22A shows a perspective view of the cover of FIG. 15 attached to the receiving element of FIGS. 1-7 when attached to the base of FIG. 8 and when in an open position; and

FIG. 22B shows a perspective view of the cover of FIG. 15 attached to the receiving element of FIGS. 1-7 when attached to the base of FIG. 8 and when in a closed position.

### DETAILED DESCRIPTION OF THE PREFERRED EMBODIMENTS

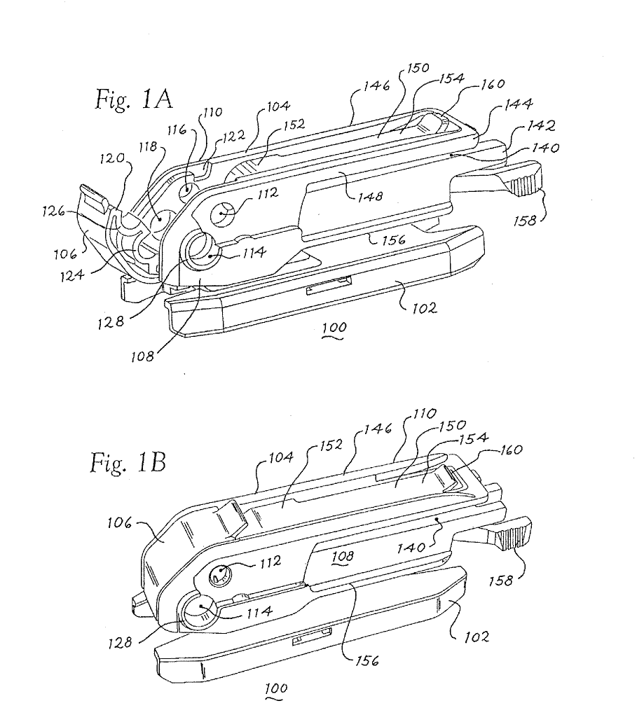

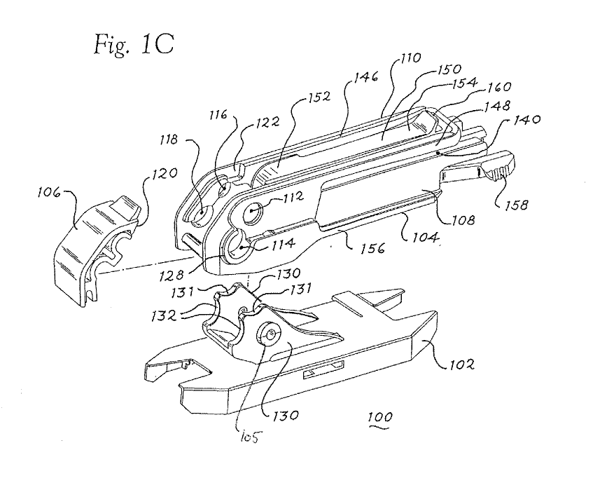

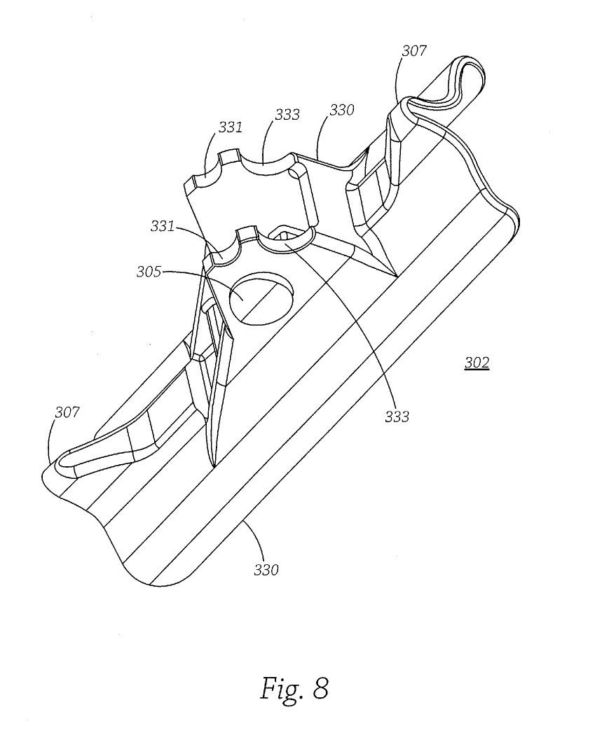

FIGS. 1A-C and 2-7 show a connector 100 for connecting a wiper blade and multiple types of wiper arms. Such a connector is described in U.S. patent application Ser. No. 13/836,333, filed on Mar. 15, 2013, the entire contents of which is incorporated herein by reference. The connector 100 includes a base 102 that is used to attach the connector 100 to a wiper blade. In particular, the underside of the base 102 includes flexible fingers that engage a bracket positioned in the central portion of the wiper blade. An example of a possible wiper blade for the connector 100 to be attached to is the wiper blade sold under the name Latitude and distributed under the Rain-X trademark by ITW Global Brands. Note that the base 102 can be revised so as to allow attachment to other types of wiper blades, such as wiper blades made by ADM21 Co., LTD., Anco, Bosch, Corea Autoparts Producing Corp., KCW Corporation, Proline, Trico and Valeo. For example, the base 102 of FIGS. 1-7 can be replaced by the base 302 of FIG. 8.

The connector 100 includes a receiving element 104 that is pivotably attached to a top portion of the base 102. In particular, the receiving element 104 has a pair of holes (not shown) facing one another on the interior surfaces of opposing side walls 108, 110 of the receiving element 104. The holes receive pins 105 of adjacent pivot stops 130 that are integral with the base 102. Thus, the receiving element 102 is able to pivot about the pins. As shown in FIG. 1C, the base 102 is integrally attached to a pair of pivot stops 130 that face one another and are parallel to one another. The pivot stops 130 are identical in shape and are positioned so that their indents 131 and 133 are aligned with and are adjacent to the bottom edges of the recesses 112, 114, 116 and 118.

In the case of base 302 of FIG. 8 being attached to the receiving element 104, the previously mentioned pair of holes of the receiving element 104 receive pins 305 of adjacent pivot stops 330 that are integral with the base 302. Thus, the receiving element 104 is able to pivot about the pins. As shown in FIG. 8, the base 302 is integrally attached to a pair of pivot stops 330 that face one another and are parallel to one another. The pivot stops 330 are identical in shape and are positioned so that their indents 331 and 333 are aligned with and are adjacent to the bottom edges of the recesses 112, 114, 116 and 118 of the receiving element 104.

Like base 102, base 302 has structure in its underside that engages a bracket positioned in the central portion of the wiper blade. As shown in FIG. 8, the base 302 has two hoods 307 into which spoilers of the wiper blade can be inserted.

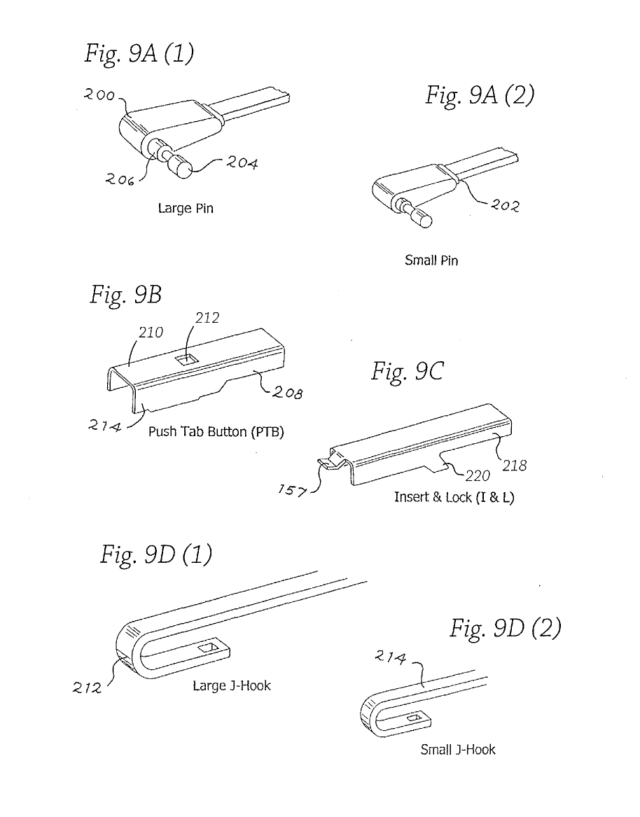

As will be explained hereafter, the receiving element 104 has a structure to receive and be connected to at least six different wiper arms, which are defined to be in at least three different classes of wiper arms. One class of wiper arms that the connector 100 can be attached is pin arm wiper arms of which pin wiper arms 200, 202 are an example thereof, wherein proximal ends of such pin arm wiper arms are shown in FIGS. 9A (1)-(2). For such attachment, a locking cap or cover 106 is pivoted to an open position as shown in FIG. 1A. Pivoting of the locking cap 106 is accomplished by a pair of pins (not shown) that face opposite one another at a lower end of the locking cap 106. The pins are inserted into corresponding openings formed in the interior surfaces of opposing side walls 108 and 110 of the receiving element 104. Thus, the locking cap 106 pivots about an axis aligned with the pins from the open position shown in FIG. 1A to a closed position shown in FIG. 1B.

With the locking cap 106 in the open position, a pin wiper arm can be attached to the connector 100 via receiving element 104. The connector 100 can accommodate multiple sizes of pin arms, such as the small and large wiper pins 200, 202 of FIGS. 9A (1)-(2). This is accomplished in part by forming a pair of recesses or openings 112 and 114 in side wall 108 and oppositely facing and identically sized recesses or openings 116 and 118 formed in the side wall 110. The upper recesses 112 and 116 have a diameter so as to correspond to the diameter of the distal portion of a small pin wiper arm 202. Similarly, the lower recesses 114 and 118 have a diameter so as to correspond to the diameter of the distal portion of a large pin wiper arm 200.

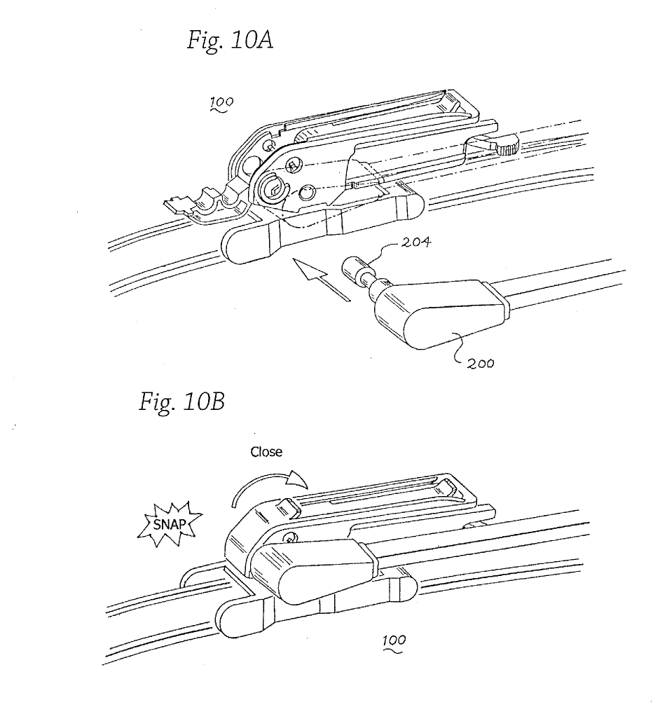

Attachment of either the large pin wiper arm 200 or the small pin wiper arm 202 is accomplished in a similar manner. In the case of attachment of the large pin wiper arm 200, the distal end 204 is aligned with the recess 114 as shown in FIG. 10A. Next, the distal end 204 is inserted through the recess 114 until the distal end 204 is received within recess 118 and extends slightly past the exterior of side wall 110. At this position, the locking cap 106 is pivoted to the closed position of FIG. 1B, wherein side protrusions 120 (see FIGS. 1A and 1C) of the locking cap 106 engage indents 122 (see FIGS. 1A and 1C) formed in the side walls 108 and 110. Engagement in the indents 122 by the side protrusions 120 causes a snapping sound as shown in FIG. 10B, which signals that the pin wiper arm is locked into attachment with the connector 100. Note that in the closed position, a c-shaped indent or surface 124 of locking cap 106 engages the middle portion 206 of the pin wiper arm 200 and presses the pin wiper arm 200 in general against the edges of the recesses 114 and 118. The c-shaped indent or surface 124 preferably has a shape that corresponds to the shape of the middle portion 206. Removal of the pin wiper arm 200 is accomplished by moving the locking cap 106 to the open position of FIG. 1A and pulling the distal end of the pin wiper arm 202 through the recesses 114 and 118.

In a manner similar to that described above with respect to large pin wiper arm 200, when the small pin wiper arm 202 is attached via insertion through recesses 112, 116, a smaller c-shaped surface 126 of locking cap 106 engages a middle portion of the pin wiper arm 202 when locking cap 106 is closed. Removal of the pin wiper arm 202 is accomplished by moving the locking cap 106 to the open position of FIG. 1A and pulling the distal end of the pin wiper arm 202 through the recesses 112 and 116.

Note that the receiving element 104 includes a c-shaped collar 128 that extends away from the recess 114 and side wall 108 so as to prevent the distal end 204 from extending too much past the recess 118 and exterior of side wall 110.

As mentioned previously, moving the cover cap 106 to the closed position locks the pin wiper arm into position. It should be pointed out that during the insertion of the pin wiper arm 200, 202 into the receiving element 104, the distal end of pin wiper arm 200, 202 engages either indents 131 or indents 132 of pivot stop 130 that are positioned within the interior of the receiving element 104. Such engagement depends on whether the pin wiper arm is inserted into recesses 112, 116 or recesses 114, 118. In addition, simultaneous engagement of the pin wiper arm to the recesses and the indents prevents the receiving element 104 from pivoting relative to the base 102.

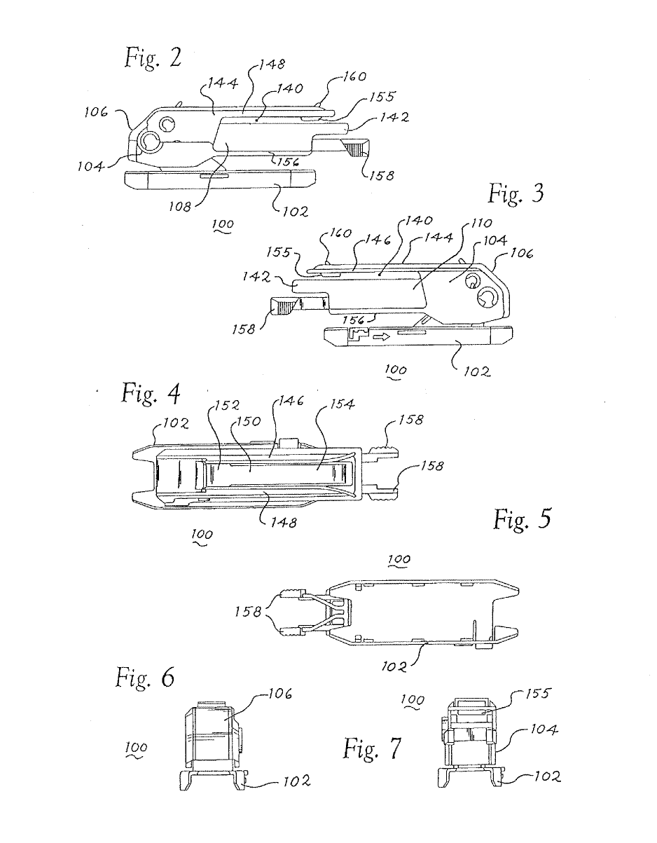

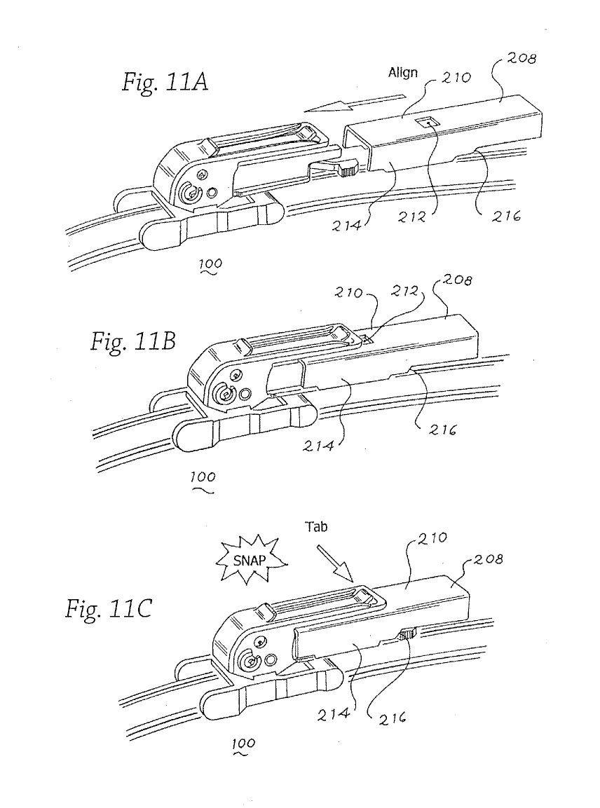

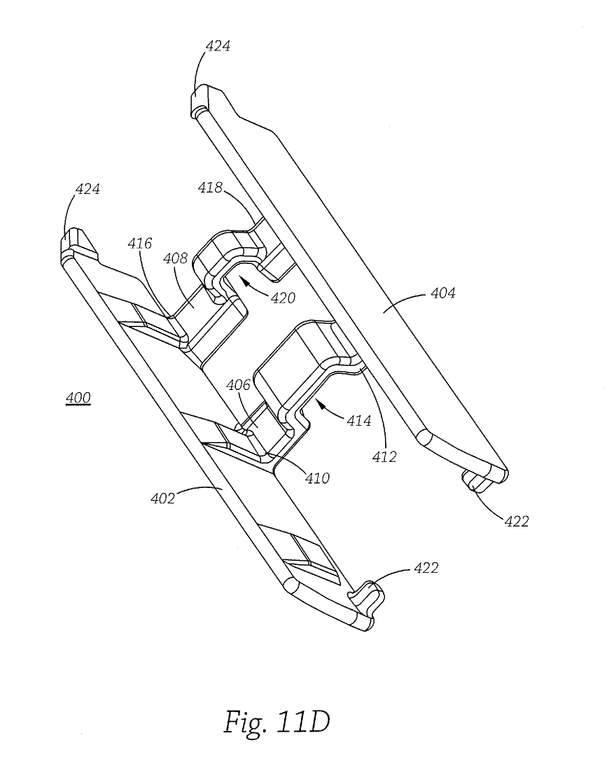

A second class of wiper arms that the connector 100 can be attached is channel arm types of wiper arms, wherein examples of such a class are the push tab button (PTB) wiper arm 208 shown in FIG. 9B and the insert & lock (I & L) wiper arm 210 shown in FIG. 9C. In the case of the PTB wiper arm 208, the entire wiper arm 208 is aligned with a slot 140 (see FIG. 11A) that is defined by the space between a support surface 142 of the receiving element 104 and an engagement surface 144 that is spaced apart from and facing the support surface 142. The slot 140 is dimensioned to snugly receive a top surface 210 of the aligned distal end of the PTB wiper arm 208 that is inserted into the slot 140 as shown in FIG. 11B. As shown in FIGS. 1A-B, the engagement surface 144 includes a first side support 146 and a second side support 148 that faces the first side support 146. The engagement surface 144 further includes an engagement tongue 150, wherein one end 152 of the engagement tongue 150 is attached to both side supports 146, 148 and an opposite end 154 of the engagement tongue 150 is unattached and has a protrusion 155 (see FIGS. 2-3 and 7) on the bottom surface of the engagement tongue 150 that faces the support surface 142. The first side support 146 and the second side support 148 move independently of the engagement tongue 150 and vice versa.

Once the top surface 210 of the PTB wiper arm 208 is inserted into the slot 140, the PTB wiper arm 208 is pushed further into the slot 140 toward the locking cap 106 until the protrusion 155 on the bottom surface of the engagement tongue 150 snaps into a rectangular opening 212 of the top surface 210 of the PTB wiper arm 208. When the snapping sound of insertion of the protrusion 155 through the opening 212 is heard, it signals that the PTB wiper arm 208 is attached to the connector 100 as shown in FIG. 11C. Note that during insertion of the PTB wiper arm 208 side flanges 214 engage lower edges 156 of the support surface 142. In addition, at the locked position shoulders 216 of the PTB wiper arm 208 are trapped from going significantly in a direction away from the locking cap 106 by a pair of flexible wing stops 158 that face one another. The flexible wing stops 158 can be pressed towards one another along a direction that is perpendicular to a longitudinal axis of the slot 140.

Note that there are situations where the width of the PTB wiper arm 208 is such that there is noticeable play between the sides of the PTB wiper arm 208 and the side walls 108 and 110 of the receiving element 104. To reduce or eliminate such play, an expander 400 is attached to the receiving element 104. As shown in FIG. 11D, the expander 400 includes a pair of identical expansion walls 402, 404 that are parallel to one another and mirror images of one another. The interior surfaces of the expansion walls 402, 404 are separated from one another by a distance of approximately 16 millimeters (mm). The opening defined between the expansion wall 402, 404 is slightly less than the separation between the exterior surfaces of side walls 108, 110 of the receiving element 104. The expansion walls 402, 404 each have a length of approximately 43, 48, and 44 mm at the top, mid and bottom sections of the wall, respectively, a height of approximately 11 mm and a thickness of approximately 1 mm.

The expansion walls 402, 404 are attached to one another by a pair of irregular beams 406, 408 that are integrally attached to the walls 402, 404 as shown in the bottom perspective view of FIG. 11D. Beam 406 has two ends 410, 412 integrally attached to the walls 402, 404, respectively. The beam 406 has a centrally located trapezoidal-like opening 414. Beam 408 has two ends 416, 418 integrally attached to the walls 402, 404, respectively. The beam 408 has a centrally located trapezoidal-like opening 420 that is smaller than opening 414. The main purpose of beams 406 and 408 are to support and hold expansion walls 402, 404 together at a specified distance. The purpose of the trapezoidal-like openings 414 and 420 is to allow clearance from the base, such as base 102 of FIG. 1A or base 302 of FIG. 8, of the connector and other components of the wiper blade, such as the air foils or spoilers, while the receiving element pivots with respect to the base.

As shown in FIG. 11 D, expansion walls 402, 404 each have a rectangular protrusion 422 and a triangular-like protrusion 424. The protrusions 422 engage indentations between the engagement surface 144 and support surface 142 of receiving element 104 to lock in firmly so as to prevent lateral movement when expander 400 is installed. Similarly, when expander 400 is installed, the protrusions 424 prevent vertical movement of the expander 400 by sitting on top of flexible wing stops 158 when the protrusions 422 engage the indentation in the locked position. Note that when the wing stops 158 are squeezed inward vertical movement of the expander 400 is possible. Once the expander 400 is attached to receiving element 104, the walls 402, 404 are exterior to and lie against the side walls 108 and 110, respectively, of the receiving element 104. Effectively, the walls 402, 404, 108 and 110 define in combination a wall that is thicker than the walls 108, 110. Such increased thickness leads to reducing or eliminating any play that the sides of the PTB wiper arm 208 will encounter when attached to the receiving element 104. Note that when spacer 400 is attached to receiving element 104, other wiper arms, such as large and small pins 200 and 202, respectively, and large and small J-hooks 212 and 214, respectively, can be optionally attached to receiving element 104. In such attachments, the spacer 400 serves no spacing function. Of course, the above mentioned large and small pins 200 and 202, and large and small J-hooks 212 and 214, can be attached to the receiving element 104 without the spacer 400 being attached thereto.

In summary, when a connector 100 is provided that is attached to a wiper blade, an expander 400 can be attached thereto so as to allow a wide profile wiper arm, such as a PTB wiper arm, to be snugly attached to the expander. When the expander 400 is removed, it allows for a narrow profile wiper arm, such as an I & L arm 210 and a narrow PTB wiper arm, to be attached to the receiving element 104 directly.

Removal of the PTB wiper arm 208 that is locked in position (with or without the expander 400 attached) is accomplished by pivoting upward a release notch 160 on the top surface of the engagement tongue 150. Such pivoting causes the protrusion 155 on the bottom surface of the engagement tongue 150 to be removed from the opening 212. At this stage, the PTB arm can be pulled out of the slot 140 once the flexible wing stops 158 are pressed towards one another.

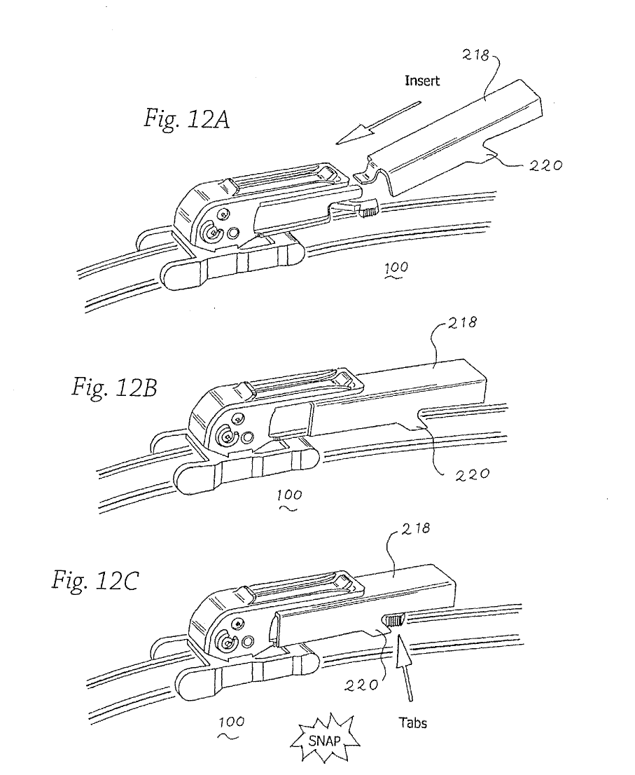

As shown in FIG. 12A, attachment of an I & L wiper arm 218 to the connector 100 is accomplished by first angling and aligning the distal end of the wiper arm 218 so that it will be inserted into the slot 140 and a channel defined between the side walls of the support surface 142. Such angling is needed so that a front edge of a curved portion 157 (see FIG. 9C) of the I & L wiper arm 218 can be freely inserted into the slot 140. Note that the slot 140 and the channel are in fluid communication with one another with the channel being positioned nearer the locking cap 106 than the slot 140. Once the curved portion 157 is inserted into the slot 140, the I & L wiper arm 218 is pivoted downward and the top surface of the I & L wiper arm 218 is pushed into the slot 140 toward the locking cover 106 as shown in FIG. 12B. Pushing of the wiper arm 218 is continued until shoulders 220 ride over the top surfaces of the wing stops 158 and the shoulders 220 pass the wing stops 158. As shown in FIG. 12C, at this point the wing stops 158 snap behind the shoulders 220 thus preventing the I & L wiper arm from being moved out of the slot 140. At this point also, the curved portion 157 enters the channel and engages a shoulder of the receiving element 104 that has a shape complementary to the shape of the curved portion 157. When the snapping sound of insertion of the wing stops 158 is heard, it signals that the I & L wiper arm 218 is attached to the connector 100.

As with the PTB wiper arm 208, there may be play between the sides of the I & L wiper arm 218 and the side walls 108 and 110 of the receiving element 104. In such a case, the expander 400 of FIG. 11C may be attached to the receiving element 104 to reduce or eliminate such play in the manner described previously with respect to the PTB wiper arm 208.

Removal of the I & L wiper arm 218 that is locked in position (with or without the expander 400 attached) is accomplished by squeezing the wing stops 158 towards each other so as to allow the shoulders 220 to move past the wing stops 158 and away from the locking cover 106. With this configuration, the I & L wiper arm 218 can be removed from the slot 140.

A third class of wiper arms that the connector 100 can be attached is J-hook wiper arms. Examples of such wiper arms are J-hook wiper arms 212, 214 of FIGS. 9D(1)-(2), wherein proximal ends of such wiper arms are shown. For such attachment, the locking cap or cover 106 is pivoted to an open position as shown in FIG. 1A.

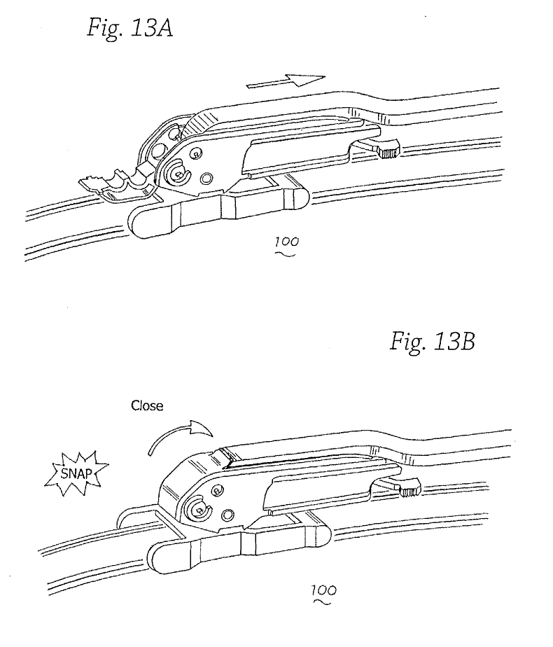

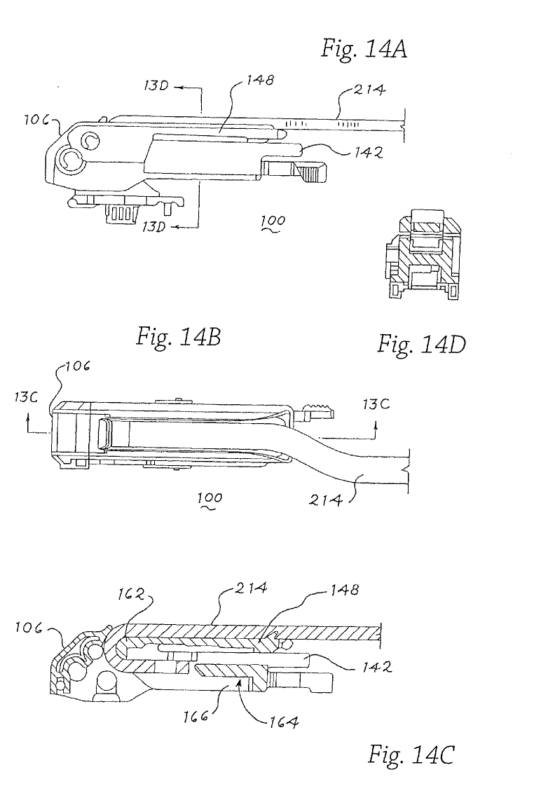

With the locking cap 106 in the open position, a J-hook wiper arm can be attached to the connector 100 via receiving element 104. The connector 100 can accommodate multiple sizes of J-hook wiper arms, such as the small and large J-hook wiper arms 212, 214 of FIGS. 9D (1)-(2). This is accomplished in part by formation of a cavity defined in part by an end portion 162, the side walls 108, 110 and the support surface 142 as shown in FIG. 14C. As shown in FIG. 14A, attachment is achieved by inserting the free end of the J-hook wiper arm 212, 214 into the cavity and pulling away from the locking cap 106 (see FIG. 13A) until the curved portion of the J-hook wiper arm 212, 214 snugly engages the end portion 162 as shown in FIG. 14C. At this position, the locking cap is snapped into the closed position shown in FIGS. 13B and 14A-C so that the J-hook wiper arm 212, 214 is locked in position. Note that in the case of the small J-hook wiper arm 214, the free end is positioned directly below the support surface 142 (see FIG. 14C). In the case of a large J-hook wiper arm 212, the free end will end up snugly engaging the bottom surface 164 of lower cavity 166 (see FIG. 14C).

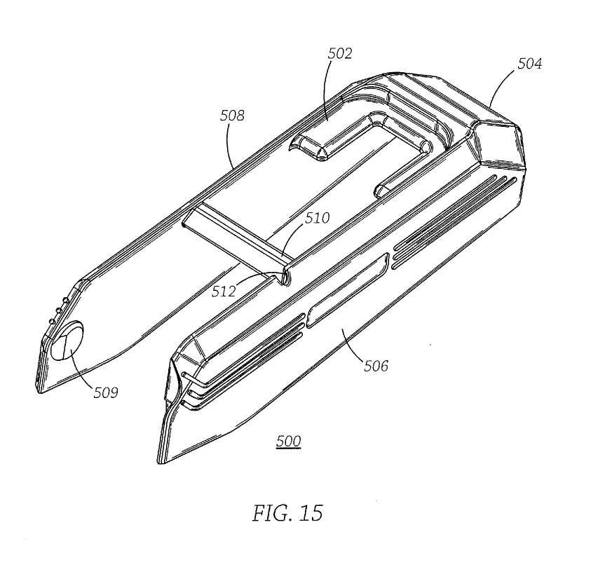

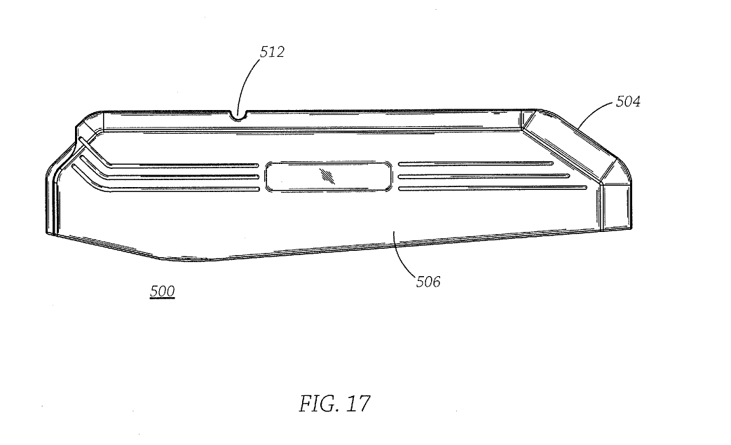

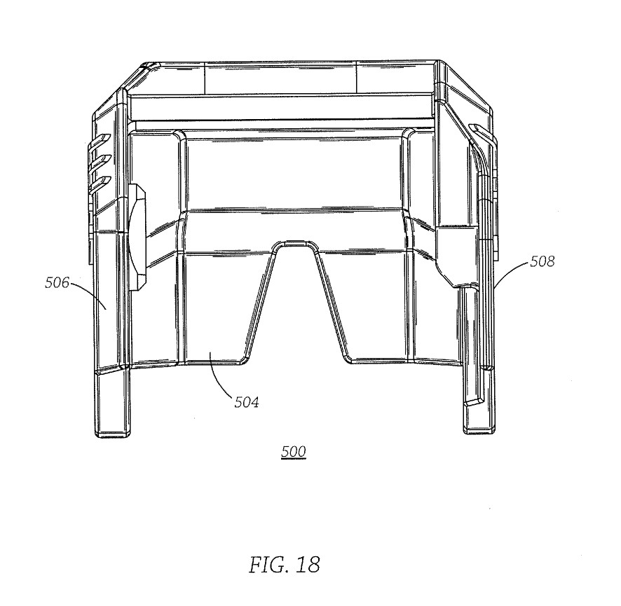

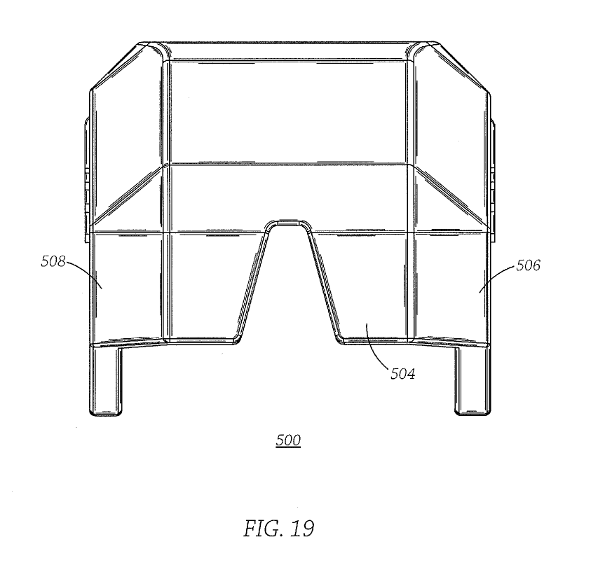

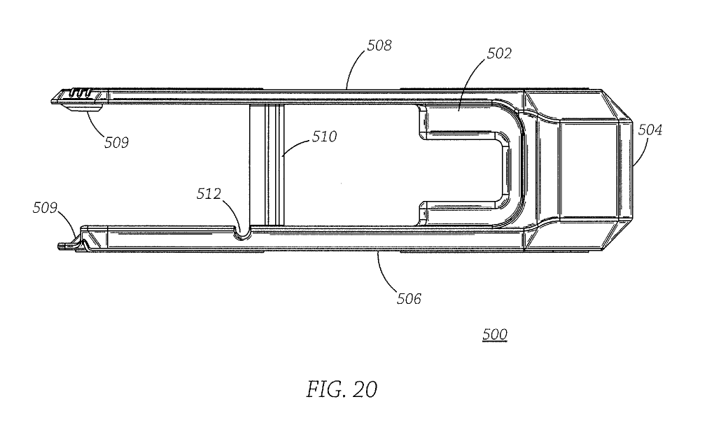

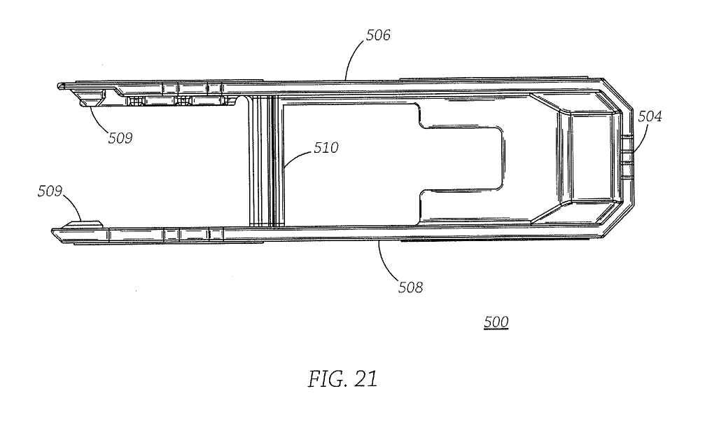

As an alternative to the embodiment of FIGS. 13A-B and 14A-D, a cover 500 as shown in FIGS. 15-21 can be attached to the connectors previously described when attached to J-hook wiper arms 212 and 214. When attached to one another, the cover 500 and the connector define a connector system. When it is desired to have the connectors attached to other types of wiper arms, the cover 500 is removed from the connector.

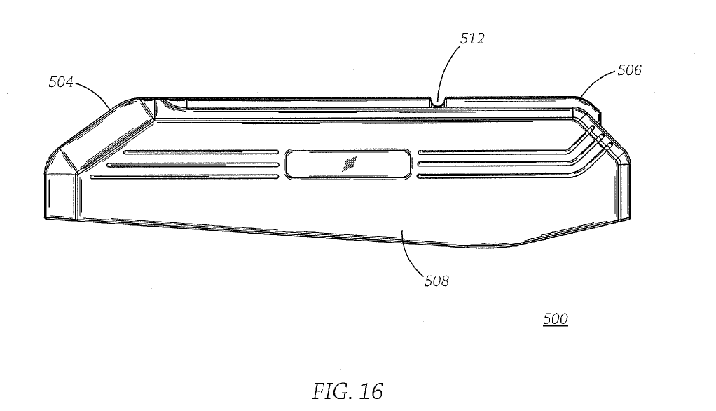

As shown in FIGS. 15-21, the cover 500 includes a top wall 502, a rear wall 504 and a pair of sides 506, 508 that are integrally attached to the top wall 502 and the rear wall 504. The side 506 is parallel to the side 508 and the sides 506, 508 are spaced from each other by approximately 23 mm including the thickness of both walls. Approximately the width of each wall is 2 mm. The front portions of each side 506, 508 has a protrusion 509, wherein the protrusions 509 face each other. In order to stabilize the relative positions of the sides 506, 508, a beam 510 is integrally attached to the upper mid-portions of the sides 506, 508. As shown in FIG. 16, the side 506 has a larger height than the side 508. Such a difference in height between sides 506 and 508 is advantageous when expander 400 is attached to the receiving element 104 for the wider version PTB wiper arm. In particular, expander 400 is not completely centered when attached to the receiving element 104 so that a gap is formed by the expander 400. The higher side 506 of cover 500 fills in/covers the gap.

As shown in FIG. 15, the cover 500 has a partially open top and an open front. Such an open design allows the cover 500 to be slipped onto the receiving element of the connector. In the case of the receiving element 104 of FIGS. 1-7, the open front of the cover 500 is aligned with the locking cap 106 when in the closed position of FIG. 1B and when either one of the J-hook arms 212, 214 is attached as shown in FIGS. 13B and 14-A-D. The cover 500 is then translated toward the rear of the receiving element 104 until the rear wall 504 covers the front of the receiving element 104. Note that the beam 510 helps to guide the cover 500 onto the receiving element 104.

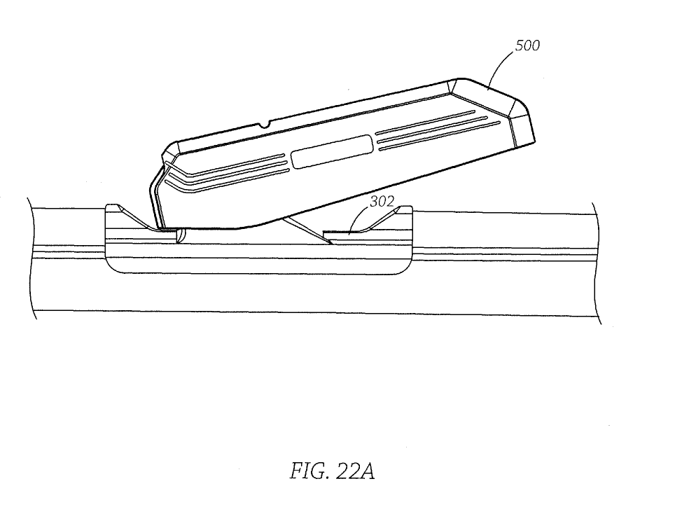

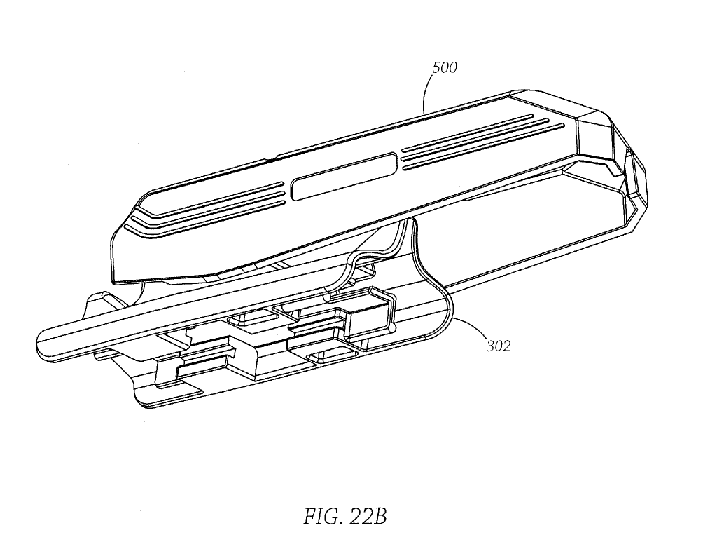

When the cover 500 covers the receiving element 104, the beam 510 lies in the space 140, between the engagement surface 144 and support surface 142, on the top surface of the receiving element 104 and so acts to prevent the cover 500 from translating downward with respect to the receiving element 104. In addition, identical protrusions 509 of the side walls 506, 508 snap into the recesses 114 and 118 of the receiving element 104 so that the cover 500 is attached to the receiving element 104. Further attachment of the cover 500 is accomplished by the sides 506 and 508 snugly/frictionally engaging the side walls 108 and 110 of the receiving element 104. Such attachment of the cover 500 is sufficient to ensure that when the receiving element 104 pivots from a first position (see FIG. 22A) to a second position (see FIG. 22B) and vice versa the cover 500 moves in unison with the receiving element 104.

Once the cover 500 is attached to the receiving element 104, a J-hook 212, 214 is attached to the receiving element 104 by opening the locking cap 106, inserting the J-hook into the receiving element 104 and closing the locking cap 106 in the manner described previously. Note that during the attachment of the J-hook wiper arms 212, 214, the beam 510 does not interfere or directly interact with the J-hook wiper arms.

If other wiper arms are to be attached to the receiving element 104, the cover 500 is removed by first flexing the front portion of the cover 500 so that the sides 506, 508 flex and protrusions 509 no longer engage the recesses 114 and 118 and then slipping off the cover 500 from the receiving element 104. Note that there is a notch 512 formed in side 506 that reduces stress in the cover 500 when the front portion of cover 500 is flexed as described previously.

It will be appreciated by those skilled in the art that changes could be made to the embodiments described above without departing from the broad inventive concept thereof. For example, the receiving element 104 previously described can be altered so it does not include structure for attaching J-hook wiper arms, but does include the previously recited structures for attaching of multiple pin wiper arms and multiple channel wiper arms, such as PTB and I & L wiper arms, as described in pending U.S. patent application Ser. No. 13/836,529, filed on Mar. 15, 2013, the entire contents of which are incorporated herein by reference. It is understood, therefore, that this invention is not limited to the particular embodiments disclosed, but it is intended to cover modifications within the spirit and scope of the present invention as defined by the appended claims. In addition, design aspects of the connector 100 in whole or without the base 102 are possible.

We claim:

1. A connector system for connecting a wiper blade and multiple types of wiper arms, the connector system comprising:
a connector comprising:
a base for attachment to a wiper blade; and
a receiving element attached to said base, said receiving element comprising a structure to receive and be connected to a wiper arm; and
a cover attached to said receiving element, said cover comprising:
a top wall;
a first side attached to said top wall and extending toward said base; and
a second side parallel to said first side, attached to said top wall and extending toward said base, wherein said second side has a height larger than a height of said first side.

2. The connector system of claim 1, wherein said receiving element comprises a structure to receive and be connected to at least six different wiper arms.

3. The connector system of claim 2, wherein said at least six different wiper arms comprise at least three different classes of wiper arms.

4. The connector system of claim 3, wherein one of said at least six different wiper arms is an I & L wiper arm.

5. The connector system of claim 2, wherein one of said at least six different wiper arms is a PTB wiper arm.

6. The connector system of claim 2, wherein one of said at least six different wiper arms is a J-hook wiper arm.

7. The connector system of claim 2, wherein one of said at least six different wiper arms is a pin wiper arm.

8. The connector system of claim 2, wherein said at least six different wiper arms comprise an I & L wiper arm, a PTB wiper arm, a first pin wiper arm, a second pin wiper arm, a first J-hook wiper arm and a second J-hook wiper arm.

9. A windshield wiper comprising:
a wiper blade;
a wiper arm; and
a connector system comprising:
a connector comprising:
a base attached to said wiper blade; and
a receiving element attached to said base and said wiper arm, said receiving element comprising a structure to receive and be connected to said wiper arm; and
a cover attached to said receiving element, said cover comprising:
a top wall;
a first side attached to said top wall and extending toward said base; and
a second side parallel to said first side, attached to said top wall and extending toward said base, wherein said second side has a height larger than a height of said first side.

10. The windshield wiper of claim 9, wherein said receiving element comprises a structure to receive and be connected to at least five other different wiper arms.

11. The windshield wiper of claim 10, wherein said wiper arm attached to said receiving element and said at least five other different wiper arms comprise at least three different classes of wiper arms.

12. The windshield wiper of claim 9, wherein said wiper arm attached to said receiving element is a J-hook wiper arm.

13. The windshield wiper of claim 9, wherein said wiper arm attached to said receiving element and said at least five other different wiper arms comprise an I & L wiper arm, a PTB wiper arm, a first pin wiper arm, a second pin wiper arm, a first J-hook wiper arm and a second J-hook wiper arm.

14. A connector for connecting a wiper blade and multiple types of wiper arms, the connector comprising:
a receiving element attached to said wiper blade, said receiving element comprising:
a first side wall;
a second side wall positioned opposite from and spaced from said second side wall, wherein exterior surfaces of said first side wall and said second side wall are spaced apart from one another at a first predetermined distance so that a first wiper arm can snugly engage said first side wall and said second side wall; and
a spacer comprising:
a first expansion wall comprising an interior surface that engages said exterior surface of said first side wall; and
a second expansion wall comprising an interior surface that engages said exterior surface of said second side wall, wherein exterior surfaces of said first expansion wall and said second expansion wall are spaced apart from one another at a second predetermined distance so that a second wiper arm snugly engages said expansion wall and said second expansion wall.

15. The connector of claim 14, wherein said second wiper arm is a PTB wiper arm.

16. The connector of claim 14, wherein said second wiper arm an I & L wiper arm.

17. A windshield wiper comprising:
a wiper blade;
a first wiper arm;
a connector comprising:
a receiving element attached to said wiper blade, said receiving element comprising:
a first side wall;
a second side wall positioned opposite from and spaced from said second side wall, wherein exterior surfaces of said first side wall and said second side wall are spaced apart from one another at a first predetermined distance so that a second wiper arm can snugly engage said first side wall and said second side wall; and
a spacer comprising:
a first expansion wall comprising an interior surface that engages said exterior surface of said first side wall; and
a second expansion wall comprising an interior surface that engages said exterior surface of said second side wall, wherein exterior surfaces of said first expansion wall and said second expansion wall are spaced apart from one another at a second predetermined distance so that said first wiper arm snugly engages said expansion wall and said second expansion wall.

18. The windshield wiper of claim 17, wherein said second wiper arm is a PTB wiper arm.

19. The windshield wiper of claim 17, wherein said second wiper arm an I & L wiper arm.

20. A method of attaching a wiper arm to a connector that is attached to a wiper blade, the method comprising:
providing a connector that is attached to a wiper blade;
attaching an expander to said connector; and
attaching a wiper arm to said expander.

21. The method of claim 20, wherein said wiper arm is a PTB wiper arm.

22. The method of claim 20, wherein said wiper arm an I & L wiper arm.

23. A method of removing a wiper arm from a connector that is attached to a wiper blade, the method comprising:
providing a connector that is attached to a wiper blade, wherein an expander is attached to said connector;
removing said expander from said connector; and
attaching a wiper arm to said connector.

24. The method of claim 23, wherein said wiper arm is a PTB wiper arm.

25. The method of claim 23, wherein said wiper arm an I & L wiper arm.
